(19) United States
(12) Patent Application Publication
(10) Pub. No.: US 2011/0123973 A1
(43) Pub. Date: May 26, 2011

(54) SYSTEMS AND METHODS FOR VISUAL TEST AUTHORING AND AUTOMATION

(75) Inventor: Gurmeet Singh, Fairfax, VA (US)

(73) Assignee: SAPIENT CORPORATION, Boston, MA (US)

(21) Appl. No.: 12/995,980

(22) PCT Filed: Mar. 13, 2009
(86) PCT No.: PCT/US2009/001607

§ 371 Date: Dec. 2, 2010

Related U.S. Application Data
(60) Provisional application No. 61/131,263, filed on Jun. 6, 2008.
(60) Provisional application No. 61/198,818, filed on Nov. 10, 2008.

(51) Int. Cl. G09B 7/00

(52) U.S. Cl. 434/322

(57) ABSTRACT

A method of a visual test authoring and automation solution framework for an enterprise comprising supporting the creation of a test case for a visual application. First, the framework allows a user to assign a user-defined name to a test element, and select an action to be performed on the test element from a menu of actions. Second, the framework stores a mapping of the user-defined name assigned to the test element to a coded name in a corresponding language of an automated testing tool. Lastly, the system uses the mapping and the action selected to create the test case in the corresponding language of the automated testing tool.

### REFERENCE TO RELATED APPLICATIONS

This application claims the benefit of and priority to U.S. Provisional Application No. 61/198,818, filed on Nov. 10, 2008, and U.S. Provisional Application No. 61/131,263, filed on Jun. 6, 2008, both applications entitled “Methods and Systems for Visual Test Authoring and Automation.” The entire contents and teachings of the above referenced applications are incorporated herein by reference.

### FIELD OF THE INVENTION

The invention relates generally to methods and systems for test authoring and test automation of form-based applications. More particularly, in various embodiments, the invention relates to providing a user interface for creating and automating tests for form-based applications.

### BACKGROUND

With the increase in complexity of form-based enterprise applications, organizations are spending more resources for testing. In addition, the current approach for progressive functional testing (i.e. testing of a new functionality) can only typically be done after the application development is complete, thereby directly extending the organization's time-to-capability. Furthermore, existing approaches to testing enterprise applications tend to be slow and too specific to certain interfaces, and thereby, requiring in-depth skills for scripting that are not generally available in within the business itself. Moreover, maintaining automation tool specific scripts can be difficult, and can impose huge costs for enterprises when changing vendors, often requiring training or hiring new employees. Thus, there exists a need for a visual test authoring and automation solution framework that enables the creation of automated test cases for functional testing of form-based applications, even when the application is in the development phase. In addition, the framework needs to be user-friendly to users without a sophisticated technical background.

WinRunner and QTP, available from Hewlett-Packard Company (HP) of Palo Alto, Calif., are examples of automated testing tools frequently used by testers. These automated testing tools are often available with a front end (i.e. SilkPlan Pro, or TestDirector) that allows users to users to author test cases and test plans, but requires the users to be familiar with the scripting language and the syntax that the underlying automated testing tool uses. In addition, these tools operate on test elements that can only be learned after the application has been coded, forcing the testing phase to occur after the development phase.

The system described in U.S. Pat. No. 7,313,564, entitled “Web-Interactive Software Testing Management Method and Computer System Including an Integrated Test Case Authoring Tool,” aims to provide a multi-user platform that manages testing requirements, and allows users to create a test cases and test plans. However, the method and system disclosed does not address two areas. One, the method and system can only be used after the application has been coded. Two, the user interface uses syntax in the language of the underlying automated testing tool, and requires the tester to have working knowledge of the test tool.

### SUMMARY OF THE INVENTION

This application discloses various methods and systems that enable enhanced visual or form-based (e.g., web-based or client/server) test authoring and automation. In particular, the systems and methods disclosed herein enable progressive functional testing to be done in an automated fashion, thereby generating an automated regression test bed for virtually free. These systems and methods enable a manual tester to write automated test scripts while the application is still under development. In addition, a tester may create full featured test cases using the user's native language (English, German, etc.) language, allowing non-sophisticated testers to create and run automated tests regardless of their technical background.

Accordingly, there is a need to resolve these problems. The visual interface of a solution framework at the present application solves the two problems of the system described in the '564 patent. The layers of abstraction of the solution framework allow testers to define names for test elements using plain English language, and hides the obscure syntax used by the underlying automated testing tool. Additionally, this system enables testers to write test cases before the target application is coded. Furthermore, the system can help to reduce the number of licenses of the automated testing tool used for automation as the licenses are used only during actual execution of test cases and not for test authoring.

In one aspect, the system described herein includes a web-based interface, an adapter, a server, and a repository. The interface and adapter may sit above existing automated testing tools (e.g., HP's QTP or WinRunner). The web-based interface enables testers to create test cases, in some embodiments, by using a pre-filled drop down menu and allowing the testers to assign easily readable names to test elements. This ability allows users to represent a test case as an easily readable, English-like construct and/or statement (if the interface is configured for English-language users). In some embodiments, the system includes an adapter, where the adapter enables converting the test cases written in English-like language to scripts in the language of the underlying automated testing tool, and enables the test execution. The adapter may be used with various automated testing tools. The repository, operatively connected to the automated testing tools and the server, stores test cases, metadata, and test results created by the testers. The web-based interface is operatively connected to the server (e.g., a web server), which handles requests from multiple users using the system concurrently and manages the flows of information.

In certain aspects, a visual test authoring and automation system generates automated testing tools script such as, without limitation, a QTP script and stores the script in a file or files for later use. Such a novel capability can be included to enable the generation of the underlying automated testing tool code (e.g., HP's QTP code) for a test case or set of test cases created using a visual test authoring tool. Then, each test case with its unique data set combination can be produced as a single test case to be executed directly by the underlying automated testing tool (e.g., HP's QTP). Thus, after a test case has been created using the visual test authoring tool, the test case can be executed directly with the underlying automated testing tool (e.g., HP's QTP) solution without requiring the visual test authoring tool.

In one exemplary use, the system enables structured creation of automated test cases by delineating roles and responsibilities among administrators, test-leads, and testers. An administrator may perform configuration activities, which may involve a one-time setup to configure the project details and the modules within a project and a scenario.

Following the configuration phase, a test-lead or any member of the test team may use the system's visual interface to rapidly create test cases and set up test-execution runs. In one aspect, a test case may be associated with an action performed on a test element. A test element may be associated with a control element on a particular screen, such as a button, a link, or a text field, where an action may be performed. A test element may also include data or any other entities present on a screen or web page, such as a spreadsheet, a data file, an excel file, a statement, a math function, a string function, and a rule. A screen may be associated with web page of a particular process, such as a “Confirm your order” screen of a checkout process on an e-commerce website. A web page, page, and/or form may be referred to as a screen. Users may define a test element by the name of the control, and the name of the screen that control is on. In another aspect, a test element may be associated with a screen or web page within a particular visual application. In some aspects, a test execution run may include a plurality of test cases.

Unlike traditional automated testing tools, the system described herein enables a tester to assign a user-defined, often descriptive, name to a test element (e.g., “Login”). The tester then assigns a user-defined name to a particular test element (e.g., “Mail link”). The tester may then select the action to be performed on the test element by using a pre-filled drop-down menu (e.g., “Click”) available on the visual interface. For example, a tester can write test cases for testing functions found in email sites such as Yahoo Mail. In the system's visual interface, a tester assigns a user-defined name to a screen/page name (e.g., Yahoo-Login), a user-defined name for a particular control element (e.g., Password), and chooses “Set Text” as the action to be performed on the selected control element.

In certain aspects, there is a one-time activity where the test-lead launches the automated testing tool, e.g., QTP, WinRunner, and identifies test elements from the automated testing tool and maps them to the user-defined names used to create the test cases in the system. An adapter may perform such task by converting the test cases written in English-like language to scripts in the language of the underlying automated testing tool, and enables the testing execution. In certain embodiments, the process is automated. Following the script conversion, the test scripts are executed in machines where the automated testing tool is installed. By implementing such adapter, the test case authoring becomes scriptless and automated, and completely abstracted from the underlying automated testing tool.

In one aspect, the creation of test cases can be performed before the target application is coded, thereby shortening the production cycle by performing testing tasks in parallel with the development phase. In addition, by moving the testing phase closer to the design phase, organizations can quickly and efficiently translate design requirements to test cases using the framework. The time saved using the design-oriented, scriptless system can not only advantageously bring business and software development closer together, but can also advantageously speed up an organization's time-to-capability by building in rapid iterative testing closer to the design phase, ensuring that the business gets what it asked for, rather than what the software developers thought it wanted.

As the system may be a solution framework that sits above existing tools like HP's QTP or WinRunner, it can virtualize these existing automated testing tools. This feature of the system provides flexibility to businesses wishing to move from one automated testing tool vendor to another and reduces related expenses such as costs of retraining the testers.

In one aspect, the system supports quality center integration. To facilitate integration with other off-the-shelf applications , the system can support importing Fusion workbook, and/or exporting to Excel workbook. In some embodiments, tools are integrated to manage test data.

In another aspect, the system can enable users to use rules to create more complex test cases. To manage a large number of test cases, the system can allow users to configure projects, modules, and scenarios. The invention will now be described with reference to various illustrative embodiments.

### BRIEF DESCRIPTION OF THE DRAWINGS

The foregoing and other objects, features, advantages, and illustrative embodiments of the invention will now be described with reference to the following drawings in which like reference designations refer to the same parts throughout the different views. These drawings are not necessarily to scale, emphasis instead being placed upon illustrating principles of the invention.

FIG. 1 is a network diagram of a visual test authoring and automation solution framework according to an illustrative embodiment of the invention.

FIG. 2 is a functional block diagram of a general purpose computer accessing the visual test authoring solution framework according to an illustrative embodiment of the invention.

FIG. 3 is a layer diagram of the web-based visual test authoring and automation framework according to an illustrative embodiment of the invention.

FIG. 4 is a work flow diagram of the visual test authoring and automation solution framework according to an illustrative embodiment of the invention.

FIG. 5 is a functional block diagram of a system for a visual test authoring and automation solution framework for an enterprise according to an illustrative embodiment of the invention.

FIG. 6 is a flow diagram of a method for a visual test authoring and automation solution framework for an enterprise according to an illustrative embodiment of the invention.

FIG. 7 is a flow diagram of another method for a visual test authoring and automation solution framework for an enterprise according to an illustrative embodiment of the invention.

FIG. 8 is a block diagram showing the mapping process for screen names in a visual test authoring and automation framework according to an illustrative embodiment of the invention.

FIG. 9 is a user interface displaying the mapping process for screen names in a visual test authoring and automation framework according to an illustrative embodiment of the invention.

FIG. 10 is a block diagram showing the mapping process for control names in a visual test authoring and automation framework according to an illustrative embodiment of the invention.

FIG. 11 is a user interface displaying the mapping process for control names in a visual test authoring and automation framework according to an illustrative embodiment of the invention.

FIG. 12 is a user interface for modifying and viewing test cases in a visual test authoring and automation framework according to an illustrative embodiment of the invention.

FIG. 13 is a user interface for editing test runs in a visual test authoring and automation framework according to an illustrative embodiment of the invention.

FIG. 14 is a user interface for viewing a summary of test case execution results in a visual test authoring and automation framework according to an illustrative embodiment of the invention.

### DESCRIPTION OF ILLUSTRATIVE EMBODIMENTS

As described above in the summary, the invention is generally directed to systems and methods that provide a system and a solution framework for using user-friendly names for test elements instead of obscure coded names in test authoring and automation, thereby, allowing even non-technical testers to create, edit, and run automated tests.

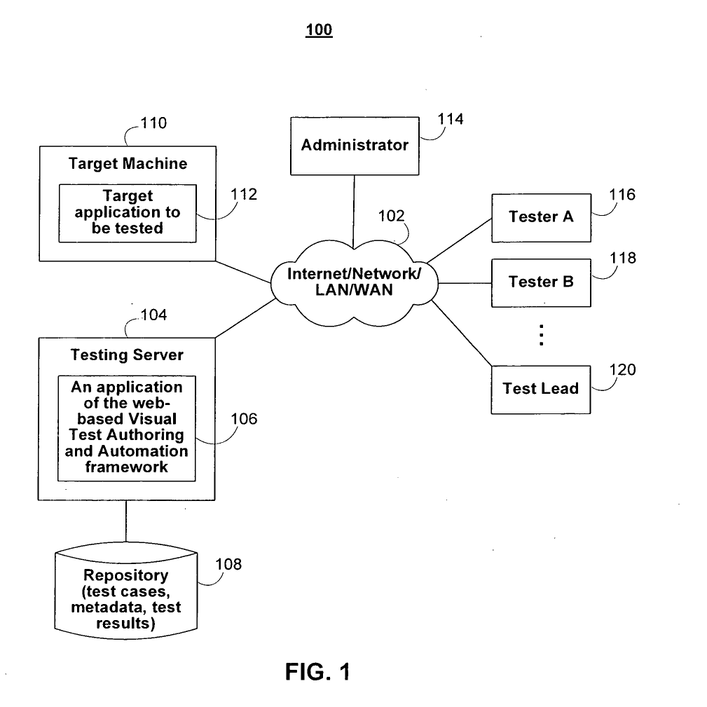

FIG. 1 is a network diagram of a Visual Test Authoring and Automation Solution Framework and/or System 100 according to an illustrative embodiment of the invention. The Framework and/or System 100 includes a Network 102, an Administrator Machine 114, Tester Machine 116, Tester Machine 118, a Test Lead Machine 120, a Testing Server 104, an Application 106 of the Framework 100, a Repository 108, a Target Machine 110, and a Target Application 112 to be tested.

The Target Machine 110 can include a computer server hosting an instance of the Target Application 112. In some instances, the Target Machine 110 may run an instance of an automated test tool. In another instance, the Target Application may be referred to as the Application Under Test (AUT). The Target Application 112 may be a commerce web site, or other kinds of form-based web application. Form-based web applications may include applications developed based on Web, .NET, Java, SAP, Siebel, Oracle, Web Services and others suitable platforms. The Testing Server 104 can a computer server implementing an instance of the Application 106, and may be suitable as a Web server. In addition, the Testing Server 104 can be coupled with a Repository 108 for storing test cases, metadata, and test results. The Repository 108 may be implemented as a database, a file storage system, version controlled repository or any suitable repository system. In one embodiment, the Repository 108 stores test scripts and screenshots of the Target Application 112 during testing. The diagram in FIG. 1 is exemplary only, in some embodiments, a machine may be configured to run a combination of the various applications shown. For instance, a single server can run both the Target Application 112 and also the Application 106 of the Framework 100. Or in another instance, a single user may play the role of an Administrator and a Test Lead, thereby combining the Administrator Machine 114 and Test Lead Machine 120 into one machine.

In some embodiments, the Application 106 is accessible by multiple users. Users may be humans with various roles such as administrators, testers, and test leads. Each user may access the Application 106 over the Network 102 using a web browser implemented on a client machine. By interacting with the Application 106, users can configure and execute test cases. In the illustrative embodiment shown in FIG. 1, the Administrator Machine 114, Tester Machine 116, Tester Machine 118, and the Test Lead Machine 120 are client machines that enable users to access the Application 106 over the Network 102. Various users and machines in FIG. 1 may be connected via LAN, WAN, or via any other suitable topology using any suitable protocol.

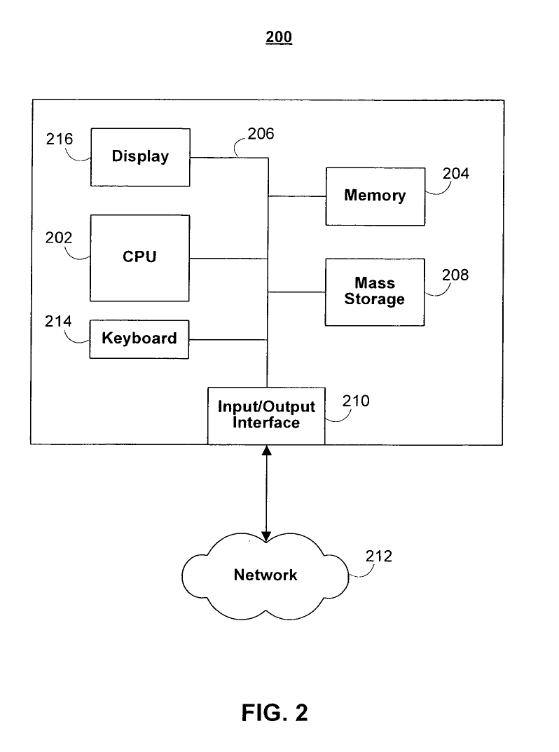

FIG. 2 is a functional block diagram of an exemplary Computer System 200. The Target Machine 110, the Testing Server 104, the Administrator Machine 114, Tester Machine 116, Tester Machine 118, and the Test Lead Machine 120 may be implemented as a General Purpose Computer 200 shown in FIG. 2. The machines may access the Application 106 through the Network 212 according to an illustrative embodiment of the invention. The exemplary Computer System 200 includes a Central Processing Unit (CPU) 202, a Memory 204, and an Interconnect Bus 206. The CPU 202 may include a single microprocessor or a plurality of microprocessors for configuring Computer System 200 as a multi-processor system. The Memory 204 illustratively includes a main memory and a read only memory. The Computer 200 also includes the Mass Storage Device 208 having, for example, various disk drives, tape drives, etc. The main Memory 204 also includes dynamic random access memory (DRAM) and high-speed cache memory. In operation and use, the main Memory 204 stores at least portions of instructions and data for execution by the CPU 202.

The Mass Storage 208 may include one or more magnetic disk or tape drives or optical disk drives, for storing data and instructions for use by the CPU 202. At least one component of the Mass Storage System 208, preferably in the form of a disk drive or tape drive, stores the databases used in System 100 of the invention. The Mass Storage System 208 may also include one or more drives for various portable media, such as a floppy disk, a compact disc read only memory (CD-ROM), or an integrated circuit non-volatile memory adapter (i.e. PC-MCIA adapter) to input and output data and code to and from the Computer System 200.

The Computer System 200 may also include one or more input/output interfaces for communications, shown by way of example, as Interface 210 for data communications via the Network 212. The Data Interface 210 may be a modem, an Ethernet card or any other suitable data communications device. To provide the functions of a Computer 104 according to FIG. 1, the Data Interface 210 may provide a relatively high-speed link to a Network 212 and/or Network 102, such as an intranet, Internet, or the Internet, either directly or through an another external interface. The communication link to the Network 212 may be, for example, optical, wired, or wireless (e.g., via satellite or 802.11 Wifi or cellular network). Alternatively, the Computer System 200 may include a mainframe or other type of host computer system capable of Web-based communications via the Network 212 and or Network 102.

The Computer System 200 also includes suitable input/output ports or may use the Interconnect Bus 206 for interconnection with a Local Display 216 and Keyboard 214 or the like serving as a local user interface for programming and/or data entry, retrieval, or manipulation purposes. Alternatively, server operations personnel may interact with the Computer System 200 for controlling and/or programming the system from remote terminal devices via the Network 212.

The components contained in the Computer System 200 are those typically found in general purpose computer systems used as servers, workstations, personal computers, network terminals, portable devices, and the like. In fact, these components are intended to represent a broad category of such computer components that are well known in the art. Certain aspects of the invention may relate to the software elements, such as the executable code and database for the server functions of the Target Application 112, or the Application 106.

As discussed above, the general purpose Computer System 200 may include one or more applications that provide features of a visual test authoring and automation framework in accordance with embodiments of the invention. The system 200 may include software and/or hardware that implement a web server application. The web server application may include software such as open source web server tools like Tomcat, JBoss or commercial ones like Weblogic, Websphere, or the like. The system 200 may also include software and/or hardware that implements a web browser for accessing the Application 106.

The foregoing embodiments of the invention may be realized as a software component operating in the Computer System 200 where the Computer System 200 is Windows workstation. Other operation systems may be employed such as, without limitation, Windows, Unix and LINUX. In that embodiment, the visual test authoring and automation solution framework can optionally be implemented as a Java/J2EE language computer program, or a computer program written in any high level language including, without limitation, .NET, C++, Perl, or PHP,. Additionally, in an embodiment where microcontrollers or DSPs are employed, the visual test authoring and automation solution framework can be realized as a computer program written in microcode or written in a high level language and compiled down to microcode that can be executed on the platform employed. The development of such software and/or firmware for applications such as a visual test authoring and automation solution framework is known to those of skill in the art, and such techniques may be set forth in DSP applications within, for example, but without limitation, the TMS320 Family, Volumes I, II, and III, Texas Instruments (1990). Additionally, general techniques for high level programming are known, and set forth in, for example, Stephen G. Kochan, Programming in C, Hayden Publishing (1983). Developing code for the DSP and microcontroller systems follows from principles well known in the art.

As stated previously, the Mass Storage 208 may include a database. The database may be any suitable database system, including the commercially available Microsoft Access database, and can be a local or distributed database system. The design and development of suitable database systems are described in McGovern et al., A Guide To Sybase and SQL Server, Addison-Wesley (1993). The database can be supported by any suitable persistent data memory, such as a hard disk drive, RAID system, tape drive system, floppy diskette, or any other suitable system. The Computer System 200 may include a database that is integrated with the Computer System 200, however, it will be understood by those of ordinary skill in the art that in other embodiments the database and Mass Storage 208 can be an external element such as databases 106, 112, 114, and 116.

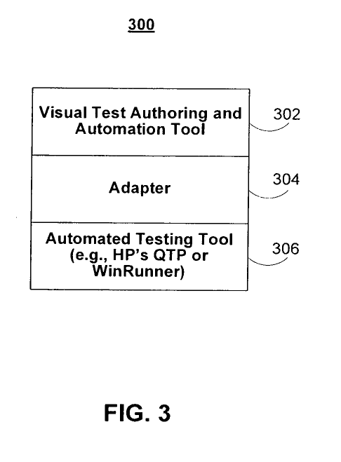

FIG. 3 is a layer diagram of the web-based Visual Test Authoring and Automation Framework 100 according to an illustrative embodiment of the invention. In some embodiments, the Framework 100 comprises three layers: the Visual Test Authoring and Automation Tool 302, the Adapter 304, and the Automated Testing Tool 306. The Visual Tool 302 may be web-based, and implemented in HTML, PHP, ASP, JSP or the like. The Adapter 304 can be implemented in any scripting language such as Perl or C++, or any other high-level programming language that can convert structured test cases written with user-defined names to the language of the underlying Automated Testing Tool 306. The Automated Testing Tool 306 can be HP's QTP, WinRunner, or like automated testing tool. In certain embodiments, the Adapter 306 may be implemented as part of the Visual Tool 302.

In some embodiments, the Visual Test Authoring and Automation Tool 302 comprises a user interface for humans to visually create and run automated tests. The user interface may be form based, and can allow for the use of user-defined names for test elements. The user-defined names enable users to define test cases using user-friendly names to identify elements on a web page and screens (i.e. web pages). Test cases may be created by selecting actions to be performed on a test element, such as a control for a particular screen. For instance, a test case can be defined for inputting a random string (action performed) into a password text field (element) on the login page (screen).

In certain embodiments, the user interface of the Visual Tool 302 is a form-based web-application that allows for the structured creation of test steps. Each test step can be stored in a relational database, and later converted to test scripts by the Adapter 304. The test steps may be translated by the Adapter 304 from structured test steps to test scripts usable by the Automated Testing Tool 306. The test scripts generated can be executed directly by the Automated Testing Tool 306. The Adapter 304 may import the test results from the Automated Testing Tool 306 for viewing and reporting by the Visual Tool 302. The Adapter 304 may be configured for various automated testing tools.

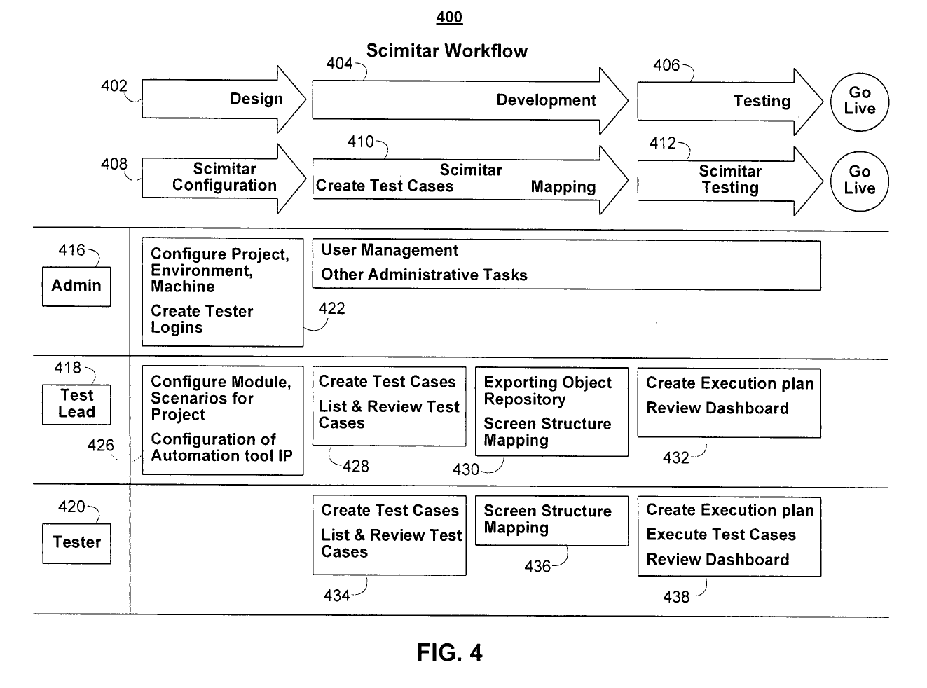

FIG. 4 is a work flow diagram of the visual test authoring and automation solution framework according to an illustrative embodiment of the invention. The Solution Framework Work Flow 400 enables structured creation of automated test cases by clearly delineating roles and responsibilities within administrative, test lead and tester roles. In one embodiment, at different stages of the test cycle, different activities are performed by test team members to configure, create and execute automated tests. An illustrative embodiment of the test cycle is shown in FIG. 4. In this embodiment, the system is operated by users with three different roles: Admin 416, Test Lead 418, and Tester 420.

In certain embodiments, the Framework 100 allows for the creation of test projects. A project may be used to describe an application or a functionality being tested. Each test project can include a plurality of modules and scenarios. Modules may be created to separate test cases for different parts of the Target Application 112, including anything from a page being tested to a name for a collection of testing scenarios. Scenarios may be created to contain test cases that ensure the business process flows are tested from end to end.

In some embodiments, the Design Phase 402 occurs concurrently with the Configuration Phase 408. During the Configuration Phase 408, the Configuration Activities 422 can be performed by Admin 416. Admin 416 can perform a one-time project set up to configure the environment, input the project details, the modules and scenarios within the project. The environment may refer to the Target Web Application 102 where the Application 106 is performing testing. In addition, Admin 416 may be involved with user-management, which involves the creation and modification of user logins.

In some embodiments, the Configuration Activities 426 can be performed by Test Lead 418. Test Lead 418 may configure modules, and scenarios within projects. In addition, Test Lead 418 may also configure the Automated Testing Tool 306.

After the Design Phase 402, the Development Phase 404 may occur. Concurrently, using the Application 106, users can create test cases and perform mapping in Test Creation Phase 410. Admin 416 may continue to perform user management and other administrative tasks. In some embodiments, Test Lead 418 and and/or Tester 420 creates and reviews lists of test cases in Test Creation Phase 428 and 434. Using the visual interface provided by the Application 106, Test Lead 418 and Tester 420 may rapidly create test cases and set up test-execution runs using user-friendly names for test elements. The Application 106 can offer the ability to use simple click-select and “drag and drop” for creating automated test cases. After creating test cases, Test Lead 418 may perform Mapping Tasks 430 such as exporting the objects repository and screen structure mapping. Tester 434 may also perform Mapping Tasks 436 that include screen structure mapping. Prior to mapping, Test Lead 418 may launch the Automated Testing Tool 306 to export the objects repository by identifying test elements in the Target Application 112. Then, Test Lead 418 may map the test elements in the language of the Automated Testing Tool 306 to the user-defined names used during Test Creation Phase 428.

After the completion of Development Phase 404, the Solution Framework Testing Phase 412 occurs concurrently with the Application Testing Phase 406. During Testing Phase 412, Test Lead 418 may perform Tasks 432 including creating an execution plan and reviewing test results. Tester 420 may perform Tasks 438 including creating an execution plan, execute test cases, and reviewing test results. Tasks 432 and 438 can be performed by leveraging the underlying Automated Testing Tool 306 to execute the test cases. The Application 106 may provide reporting of test results from test execution.

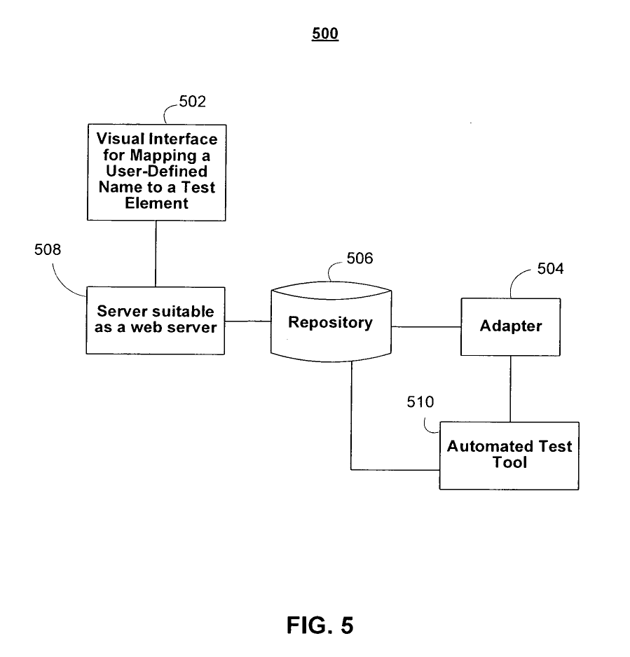

FIG. 5 is a functional block diagram of a System 500 for a visual test authoring and automation solution framework 100 for an enterprise according to an illustrative embodiment of the invention. The System 500 comprises a Visual Interface 502 for mapping a user-defined name to a test element or screen, a Server 508 suitable as a web server, a Repository 506 for storing test cases, an Adapter 504, and an Automated Test Tool 510. In some embodiments, the Server 508 is operatively coupled to the Repository 506 and the Visual Interface 502. The Repository 506 may be coupled to the Adapter 504. The Adapter 504 may be operatively coupled to the Automated Test Tool 510.

Using the Visual Interface 502, Test Lead 418 and Tester 420 can perform tasks for mapping a user-defined name to a test element. Test Lead 418 and/or Tester 420 may also use the Visual Interface 502 to create test cases. The Visual Interface 502 is configured to capture the mappings and store them in Repository 506. The Adapter 504 may be configured to convert the user-defined name of a test element into a corresponding element in the Automated Testing Tool 306 using the mappings stored in the Repository 506. At execution, the Adapter 504 creates test scripts in the corresponding language of the Automated Testing Tool 306. In certain embodiments, the Adapter 504 can store test scripts in Repository 506. The Repository 506 may have a computer readable storage medium for storing said test cases created by Test Lead 418 or Tester 420, and the test scripts created from the test cases. The Automated Test Tool 510 may be configured to execute the test scripts stored in the Repository 506. Alternatively, the Automated Test Tool 510 may execute the test scripts directly from the Adapter 504.

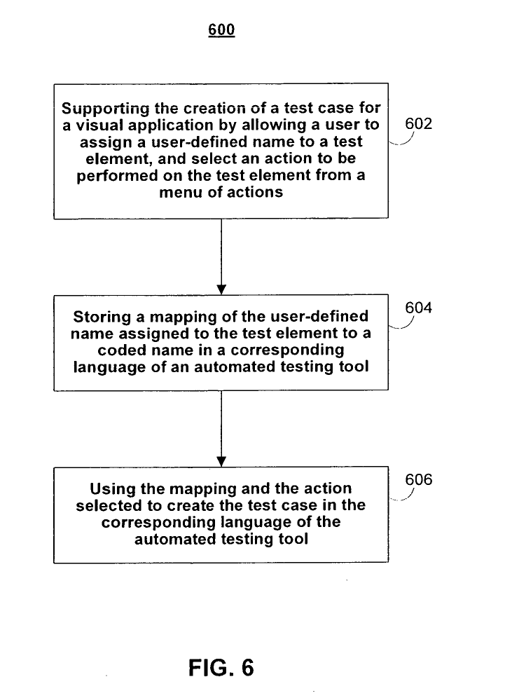

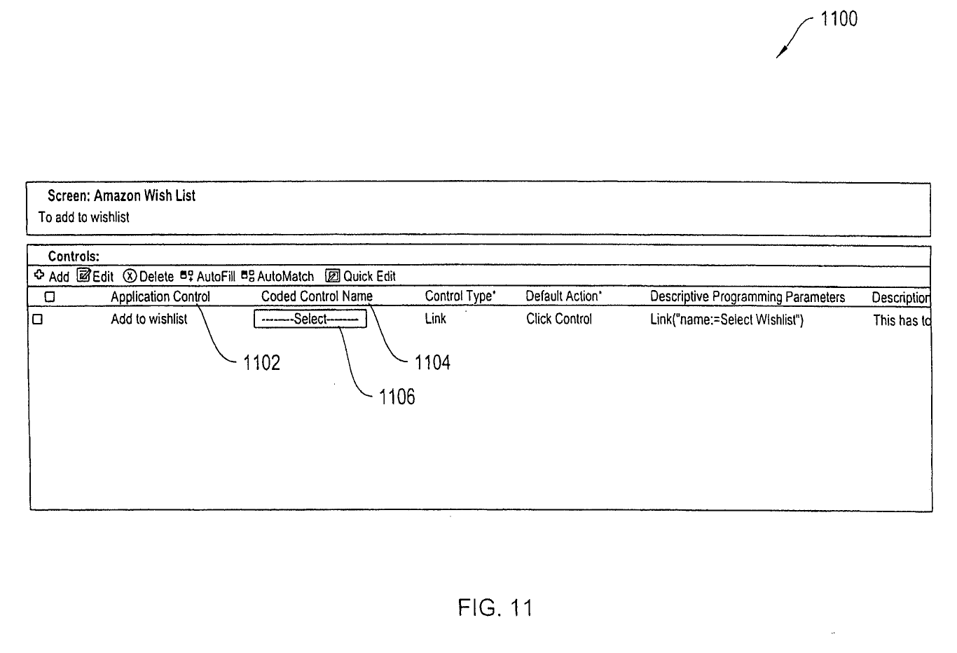

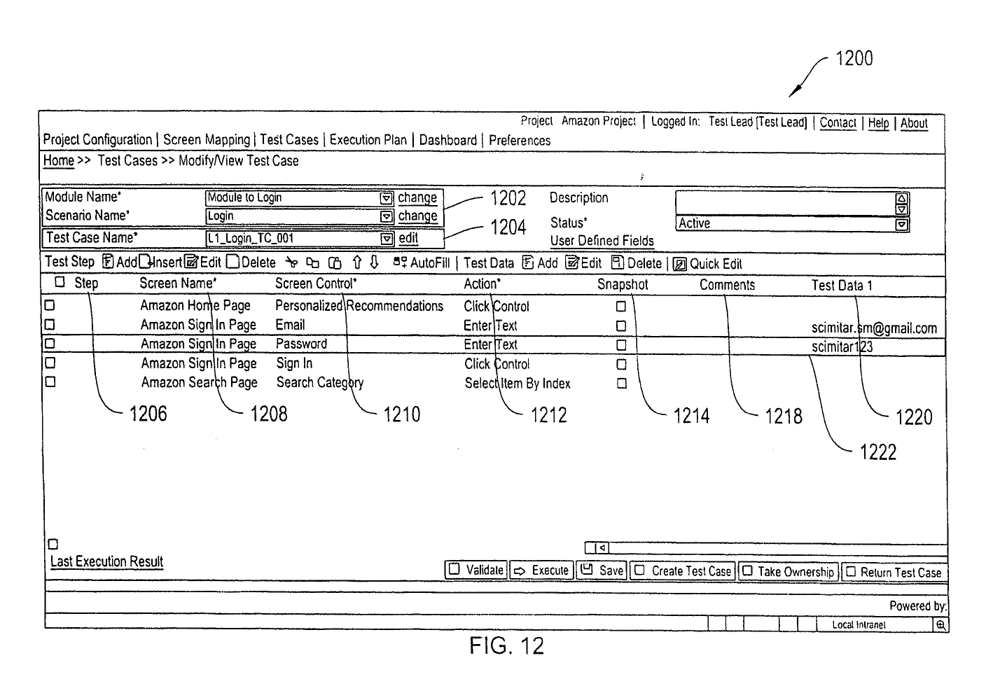

FIG. 6 is a flow diagram of a method 600 for a visual test authoring and automation solution framework for an enterprise according to an illustrative embodiment of the invention. In certain embodiments, the method 600 may be employed by the System 500 or Framework 100 to advantageously facilitate test authoring and automation. The method 600 may also enable progressive functional testing in an automated fashion. First, the System 500 or Framework 100 supports the creation of a test case for a visual application by allowing a user to assign a user-defined name to a test element, and select an action to be performed on the test element from a menu of actions (Step 602). In certain embodiments, the visual application is the Target Application 112, and may be a form-based application, and may be referred to as Application Under Test (AUT). The user may be Test Lead 418 or Tester 420, and can use the Visual Interface 502 provided by the Application 106 to create the test case. Test cases created may be stored in Repository 506 or Repository 108. An example of the assignment of user-defined names to coded names of test elements is shown in FIG. 11. Using the Visual Interface 502, the user can easily assign a user-defined name to a test element on a screen of the Target Application 112, as illustrated in the screenshot 1200 shown in FIG. 12. Additionally, the method may provide the ability to access external data files.

Second, the System 500 or Framework 100 stores a mapping of the user-defined name assigned to the test element to a coded name in a corresponding language of an Automated Testing Tool 306 (Step 604) in the Repository 108 or Repository 506. By allowing for users, such as a Test Lead 418, to map the user-defined name and action to coded names in the language of the Automated Testing Tool 306, Step 604 enables any user, such as Tester 420, to create test cases without prior programming knowledge of the syntax used in the underlying Automated Testing Tool 306.

Third, the Application 106 or Adapter 304 or Adapter 504 uses the mapping and the action selected to create the test case in the corresponding language of the Automated Testing Tool 306 (Step 606). In some embodiments, the method enables the test cases to be written before the visual application is coded. Finally, in some embodiments, the test case is executed. In certain embodiments, the test case is executed by the Testing Server 104 or Server 508. The Application 106 or Visual Tool 302 may leverage the underlying Automated Testing Tool 306 for executing the test cases, and displaying the results from test execution through the Visual Interface 502.

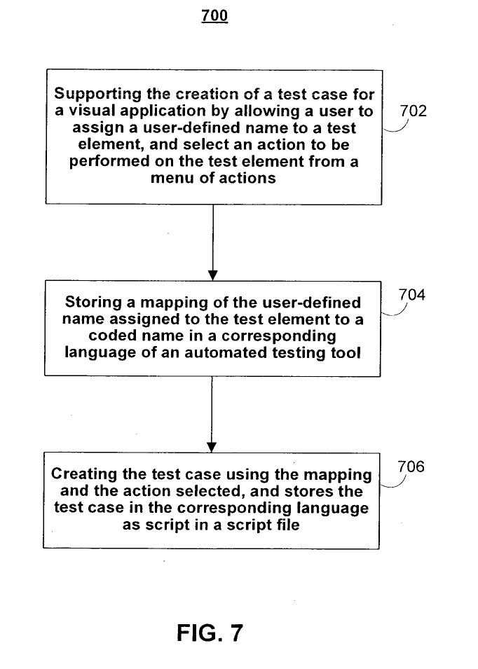

FIG. 7 is a flow diagram of another method for a visual test authoring and automation solution framework for an enterprise according to an illustrative embodiment of the invention. First, the System 500 or Framework 100 supports the creation of a test case using a Visual Tool 302 by assigning a user defined name to a test element and selecting an action to be performed on the test element from a menu of actions (Step 702). Second, the System 500 or Framework 100 stores a mapping of the user-defined name assigned to the test element to a coded name in a corresponding language of an Automated Testing Tool 306 (Step 704) in the Repository 108 or Repository 506. The mapping may be displayed to Test Lead 418 or Tester 420 on the Visual Interface 502. Third, the Application 106 or Adapter 304 or Adapter 504 creates the test case using the mapping and the action selected, and stores the test case in the corresponding language as script code in a script file (Step 706). The script file created may be in Repository 506 or Repository 108. Finally, in some embodiments, the System 500 or Framework 100 executes the test case by executing the script code of the script file. The script file may be executed on the Testing Server 104 to test the Target Application 112. In execution, the Testing Server 104 can be configured to read and/or write data from external databases (e.g. SQL Server, DB2, and Oracle) used by the Target Application 112. In some embodiments, the Testing Server 104 can capture snapshots and/videos during the execution of a test case in standard audio, image and video formats such as JPEG, mp3 and WMV.

In other embodiments, the System 500 or Framework 100 executes the test case using the Automated Testing Tool 306, independent of the Visual Tool 302, by executing the script code of the script file. Test execution can occur independently on a separate server machine, where the machine is not required to implement the Application 106, Adapter 304, Adapter 504, nor the Visual Tool 302. In addition, the test scripts created can be manually modified by a test programmer, providing more flexibility for experienced testers to make changes and improvements to the test scripts. In addition, decoupling the test execution process from the test creation process allows testers to easily reuse test scripts for other applications, without having to recreate test cases using the Visual Tool 302 or the Application 106.

The process of screen and control mapping in the solution framework 100 can include a two step process. In one embodiment, the Test Lead 418 and/or Tester 420 first analyze the Target Application 112 and its design requirements. Then, Test Lead 418 and/or Tester 420 identifies the key test elements (i.e. screens and control elements) that needs to be tested, and define user-friendly names for each screen and control elements. This list of user-friendly names may be stored in the Application 106 or Repository 108, and can be used to create test cases in the Application 106. The web-based, visual interface for test authoring and automation enables users to create and execute tests without having the technical background needed for creating test scripts. Once the Target Application 112 is built, Test Lead 418 and/or Tester 420 can then use the Automated Testing Tool 306 to identify the coded names. In one embodiment, a user can launch HP's QTP and use the Object Repository Manager to build a repository of coded names of the screens and controls to be tested. The collection can then be exported in to a format readable by the Framework 100. This process allows for the Framework 100 to import the object repository, and thereby learn the coded names. In some embodiments, the coded names are mapped to the user-friendly names as a one-time exercise when using the Solution Framework 100. The mapping can allow the Adapter 304 to translate the automated test cases created using the Visual Tool 302 to a format readable by the Automated Testing Tool 306, and allow the Tool 306 to execute the test cases.

In one embodiment, users may create test cases when the Target Application 112 is not yet ready. First, Admin 416 may login and create a project. Then, Admin 416 can create accounts for Test Lead 418 and Tester 420. Test Lead 418 can add modules and scenarios, and specify the environment and machines for the project. Test Lead can proceed to add screens and controls to mapping lists without specifying the coded names. Test Lead 418 and/or Tester 420 may create test cases, and specify the name of each test case, and the module and scenario each test case belongs to. At this time, Test Lead 418 may use QTP to create and export an object repository. After importing the repository into the Framework 100, Test Lead 418 and/or Tester 420 can now create mappings between the user-friendly names and the coded names of the screens and controls within the imported object repository. After creating the mappings, Test Lead 418 and/or Tester can create a test run by assembling a list of planned test cases. Lastly, users may execute the test run and view its results through Visual Tool 302.

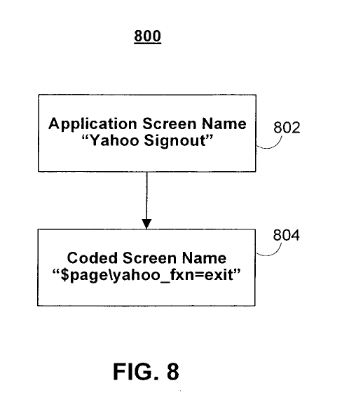

FIG. 8 is a block diagram showing the mapping process for screen names in a visual test authoring and automation framework according to an illustrative embodiment of the invention. The Adapter 304 or the Adapter 504 can map a user-defined Application Screen Name 802 to the Coded Screen Name 804 of a test screen used in the Automated Testing Tool 306. An example of an Application Screen Name 802 is “Yahoo Signout”, and Name 803 is mapped to a Coded Screen Name 804 “$page\yahoo_fxn=exit”. A user can create screen mappings through the use of the Application 106 or the Visual Tool 302 or Visual Interface 502.

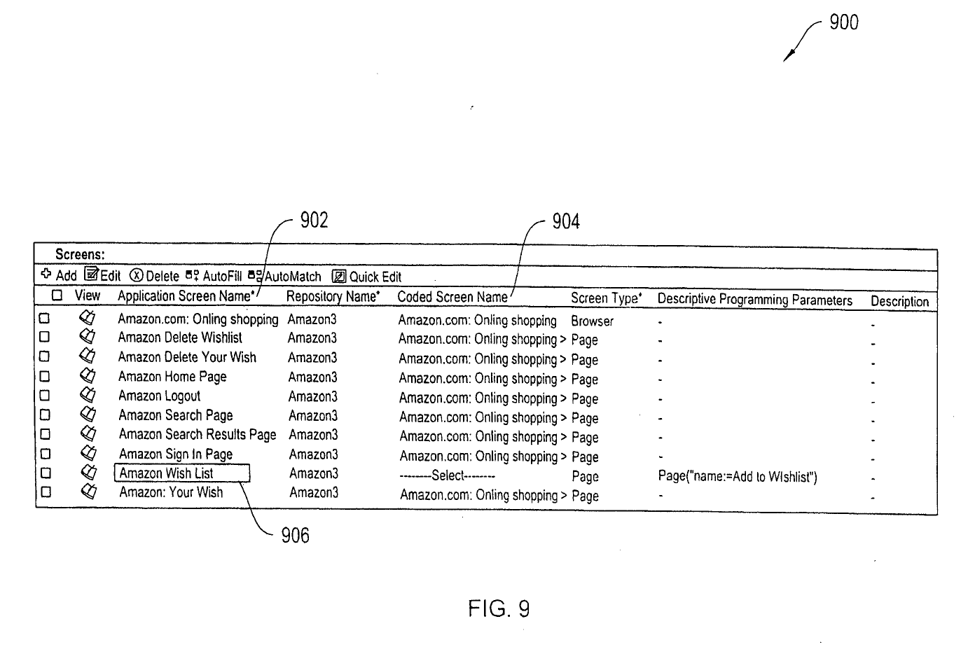

FIG. 9 is a user interface displaying the mapping process for screen names in a visual test authoring and automation framework according to an illustrative embodiment of the invention. In this illustrative embodiment, the Screen Mapping Interface 900 is a form-based web interface that allows users to generate mappings between user-friendly screen names to coded screen names. The interface may be provided by the Application 106 or Visual Tool 302 or Visual Interface 502. The Screen Name Mapping Interface 900 comprises displaying a table listing of mappings, with columns for Application Screen Name 902 and Coded Screen Name 904. Using the interface, a user can specify a user-friendly screen name in the field for Application Screen Name 902, such as one shown in Box 906, e.g. “Amazon Wish List”. Once the Application Screen Name 802 has been specified, Test Lead 418 can select from a menu of Coded Screen Names, such as Coded Screen Name 804 to complete the mapping.

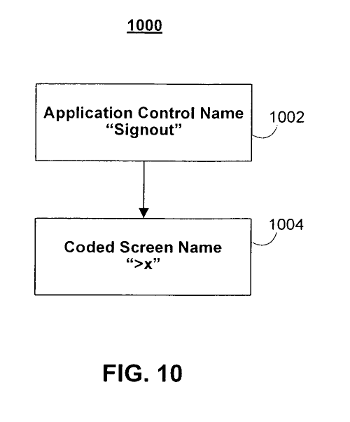

FIG. 10 is a block diagram showing the mapping process for control names in a visual test authoring and automation framework according to an illustrative embodiment of the invention. The Adapter 304 or the Adapter 504 can map a user-defined Application Control Name 1002 to the Coded Control Name 1004 of a test element used in the Automated Testing Tool 306. An example of an Application Control Name 1002 is “Signout”, and Name 1002 is mapped to a Coded Control Name 1004 “>x”. A user can create control mappings through the use of the Application 106 or the Visual Tool 302 or Visual Interface 502.

FIG. 11 is a user interface displaying the mapping process for control names in a visual test authoring and automation framework according to an illustrative embodiment of the invention. In this illustrative embodiment, the Control Name Mapping Interface 1100 is a form-based web interface that allows users to generate mappings between user-friendly control names to coded control names. The interface may be provided by the Application 106 or Visual Tool 302 or Visual Interface 502. The Control Name Mapping Interface 1100 comprises displaying a table listing of mappings, with columns for Application Control 1102 and Coded Control Name 1104. Using the interface, a user can specify a user-friendly control name in the field for Application Control 1102. In certain embodiments, Box 1106 provides the functionality for Test Lead 418 to select from a list of coded control names. Once the Application Control Name 802 has been specified, Test Lead 418 can select from a menu of Coded Control Names, such as Coded Control Name 1004, to complete the mapping.

FIG. 12 is a user interface for modifying and viewing test cases in a visual test authoring and automation framework according to an illustrative embodiment of the invention. In certain embodiments, the Visual Tool 302 or the Application 106 gives the users the ability to create test cases in a particular defined module and test scenario. A user may define a test case which comprises of a sequence of test steps. The Test Case Creation Interface 1200 is a form-based web interface that allows users without a technical background to create test cases. In some embodiments, Test Lead 418 or Tester 420 may define a list of user-friendly names for screens and controls before the creation of test cases. On the Interface 1200, Tester 420 or Test Lead 418 may create, modify and view a list of test steps. In the Region 1202, Tester 420 or Test Lead 418 may specify the module and scenario that the test case belongs to. Users may also specify a unique name and a written description for the test case in Region 1204 and Region 1206, respectively. In certain embodiments, users can specify the values for fields: Step 1206, Screen Name 1208, Screen Control 1210, Action 1212, Snapshot 1214, Comments 1218, and Test Data 1220. The Step 1206 specifies the order of the steps to be performed in the test case. The user may define user-friendly names for the screen and control element in Screen Name 1208 and Screen Control 1210, respectively.

To specify an Action 1212, users may select from a drop down menu of pre-defined actions to be performed on a Screen Control 1210. The pre-defined actions may also be editable, and users may add/define new actions. In some embodiments, by clicking on the check box for Snapshot 1214, a screenshot of the Target Application 112 during the execution of the test case is stored in Repository 108. Users may optionally enter comments for a particular test case in the Comments 1218 field. Users may optionally define rules to control the flow of execution of a series of test steps. For instance, the application 106 provides the functionality to associate rules and statements (i.e. IF, ELSE-IF, LOOP, EXIT, EXECUTE and GOTO) to test steps. Rules defined for test steps play an important role in deciding the flow of control in testing. Users can choose to skip or execute the test step in question based on conditions specified by these rules, or even to jump to a different test step or test case.

An example of a test step, shown in Row 1222, specifies a step to enter a password in a text field. In operation, Test Lead 418 defines mappings between application names to coded names using the Screen Name Mapping Interface 900 and Control Name Mapping Interface 1100. In some embodiments, the Adapter 304 uses the data in Row 1222 and mappings to create test scripts in the language of the underlying Automated Testing Tool 306. The Tool 306 then executes each test step in a test case. In this example, the test script created is configured to enter text “scimitar123” in the password field on the “Amazon Sign In Page”.

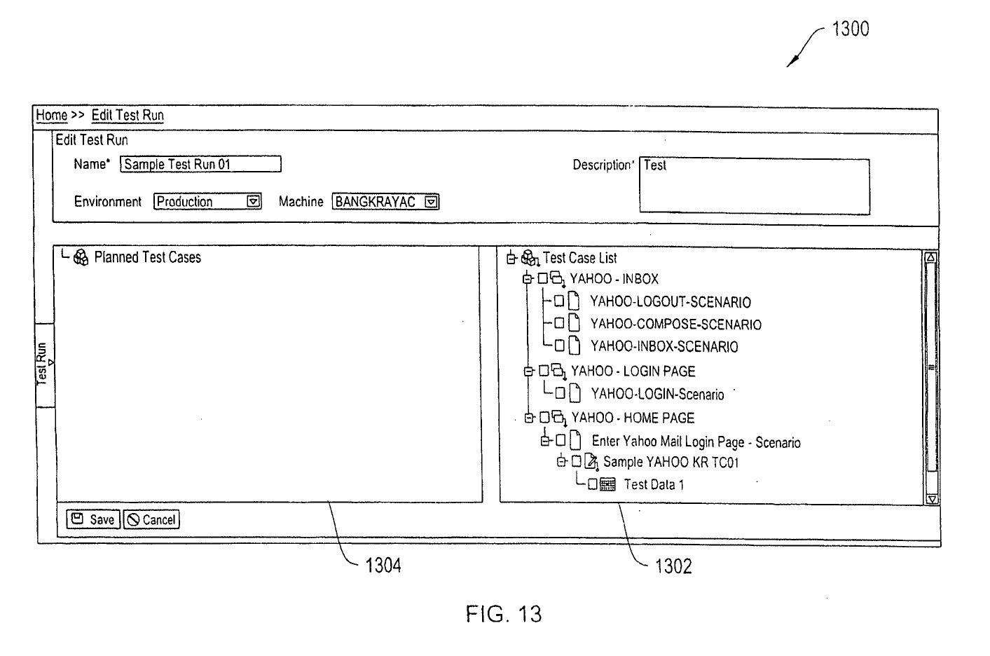

FIG. 13 is a user interface for editing test runs in a visual test authoring and automation framework according to an illustrative embodiment of the invention. In some embodiments, Test Lead 418 or Tester 420 can define a test run comprising a plurality of test cases, using the Edit Test Run Interface 1300. These test runs can be executed and monitored remotely. On the right hand side, Test Cases Region 1302, the interface displays a tree list view of test cases first grouped by screen (top level), scenarios (second level), test case (third level), and test data (fourth level). A user may drag and drop the test cases from Region 1302 to the left hand side, Planned Cases Region 1304, to build a list of planned test cases for a particular test run. Test runs may be stored in Repository 108. Additionally, users may configure an execution plan to execute a list of test runs.

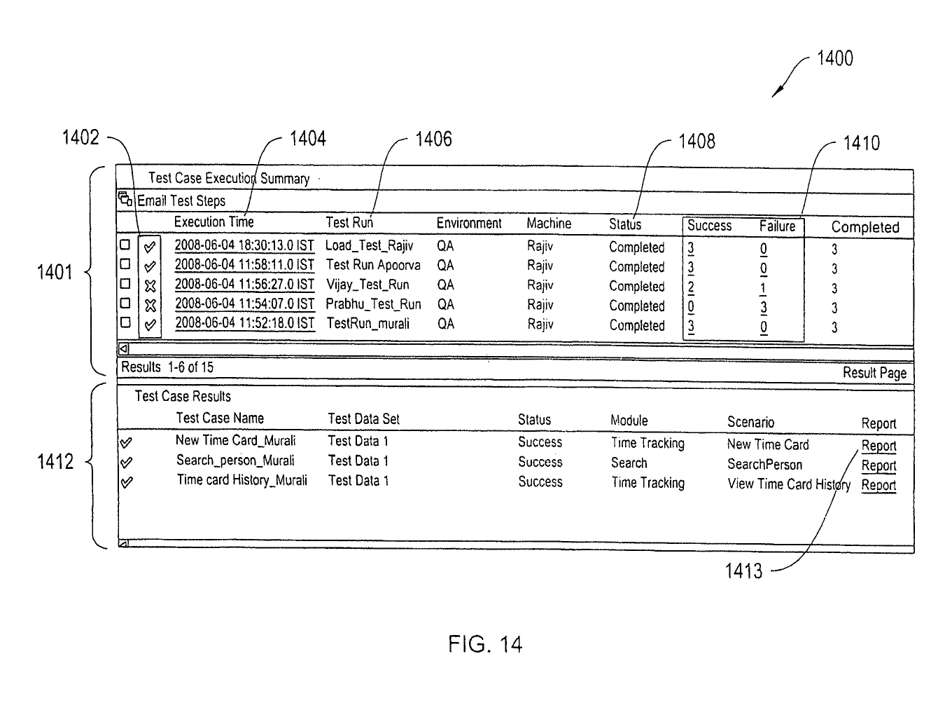

FIG. 14 is a user interface for viewing a summary of test case execution results in a visual test authoring and automation framework according to an illustrative embodiment of the invention. At any point of testing, users may view, on Dashboard Interface 1400, an at-a-glance Test Case Execution Summary 1401. The Interface 1400 may provide a graphical user interface that consolidates and present the status summary of all the latest test runs. The Interface may also automatically refresh periodically. In some embodiments, a Interface 1400 displays an icon in Icon Column 1402 to denote success or failure of a test case. In addition, Execution Time 1404, name of Test Run 1406, Status 1408 is also displayed. In Area 1410, the number of successful and failed test cases in the test run is displayed. Upon clicking on a link associated with a test run, the details of the test run results is displayed in Test Case Results 1412. A user may click on a Report Link 1413 to obtain the steps and status of a particular test case. The results may be exported to a Comma-Separated Values (CSV) file, and/or sent to users by email.

What is claimed is:

1. A method for visual test authoring and automation comprising:
(a) supporting the creation of a test case for a visual application by allowing a user to assign a user-defined name to a test element and select an action to be performed on the test element from a menu of actions;
(b) storing a mapping of the user-defined name assigned to the test element to a coded name in a corresponding language of an automated testing tool; and
(c) using the mapping and the action selected to create the test case in the corresponding language of the automated testing tool.

2. The method of claim 1 comprises executing the test case.

3. The method of claim 1, wherein the visual application includes form-based applications.

4. The method of claim 1, wherein the mapping is created via a web-based interface to a visual test authoring and automation solution framework.

5. The method of claim 4, wherein the solution framework includes the automated testing tool.

6. The method of claim 1 comprises enabling automated testing of a new feature.

7. The method of claim 1 comprises enabling the test cases to be written before the visual application is coded.

8. The method of claim 1 comprises providing the ability to access external data files.

9. The method of claim 1, wherein the test element includes at least one of a control element on a screen, a function element, and an operation element.

10. The method of claim 9, wherein the control element includes at least one of a clickable area, a button, a text field, and a link.

11. The method of claim 9, wherein the screen includes at least one of a web page, a logical screen, and a form.

12. The method of claim 1, wherein a test element includes at least one of a screen, a page, and a form.

13. The method of claim 1, wherein the test element includes at least one of spreadsheet, data file, excel file, statement, math function, string function, and a rule.

14. A visual test authoring and automation solution framework comprising:
(a) a visual interface, operatively coupled to a web server, for capturing a mapping of a user-defined name to a test element in a visual application;
(b) the web server, operatively coupled to a repository and the visual interface, storing the captured mapping in a repository;
(c) the repository having a computer readable storage medium for storing mappings and test cases created by the user; and
(d) an adapter, coupled to the repository and automated test tool, for converting the user-defined test element into a corresponding test element in an automated testing tool; and
(e) the automated testing tool, wherein the tool is operatively coupled with adapter.

15. The system of claim 14, wherein the automated test tool is configured to execute the test case.

16. The system of claim 14, wherein the visual application includes form-based applications.

17. The system of claim 14, wherein the visual interface is a web-based interface to the visual test authoring and automation solution framework.

18. The system of claim 14, wherein the solution framework includes the automated testing tool.

19. The system of claim 14, wherein the solution framework enables automated testing of a new feature.

20. The system of claim 14, wherein the solution framework comprises enabling the test cases to be written before the visual application is coded.

21. The system of claim 14, wherein the server provides the ability to access external data files.

22. The system of claim 14, wherein the test element includes a control element on a screen.

23. The system of claim 22, wherein the control element includes at least one of a clickable area, a button, a text field, and a link.

24. The system of claim 22, wherein the screen includes at least one of a web page and form.

25. The system of claim 14, wherein a test element includes at least one of a screen, a page, and a form.

26. A method of form-based test authoring and automation comprising:
(a) supporting the creation of a test case for a visual application by allowing a user to assign a user-defined name to a test element, and select an action to be performed on the test element from a menu of actions;
(b) storing a mapping of the user-defined name assigned to the test element to a coded name in a corresponding language of an automated testing tool;
(c) creating the test case using the mapping and the action selected; and
(d) storing the test case in the corresponding language as script code in a script file.

27. The method of claim 26 comprising executing the test case by executing the script code of the script file.

28. The method of claim 27 comprising executing the test case using the automated testing tool, independent of the solution framework, by executing the script code of the script file.

29. A visual test authoring and automation solution framework comprising:
(a) a visual interface for mapping a user-defined name to a test element in a visual application;
(b) an adapter configured create test scripts by at least converting the test element into a corresponding test element in an automated testing tool;
(c) a repository having a computer readable storage medium for storing test cases created by the user as script code in a script file, and test scripts created by the adapter;
(d) a server suitable as a web server operative coupled to the repository and visual interface, wherein the server is configured to execute the test scripts; and
(e) an interface for outputting the script file.

30. The framework of claim 29 comprising an automated testing tool for receiving the script file and executing the script code of the script file.

31. The framework of claim 30, wherein the automated testing tool executes the script code independently from the solution framework.
